(19) United States
(12) Patent Application Publication
(10) Pub. No.: US 2004/0244239 A1
(43) Pub. Date: Dec. 9, 2004

(54) Object holder

(76) Inventor: Karl-Heinz Gotz, Linz (AT)

Correspondence Address: WILLIAM COLLARD, COLLARD & ROE, P.C., 1077 NORTHERN BOULEVARD, ROSLYN, NY, 11576, US

(21) Appl. No.: 10/487,486

(22) PCT Filed: Aug. 22, 2002
(86) PCT No.: PCT/AT02/00251

(30) Foreign Application Priority Data
Aug. 23, 2001 (AT) A 1334/2001

(51) Int. Cl. G09F 1/10

(52) U.S. Cl. 40/124.2

(57) ABSTRACT

An apparatus is described for holding objects (11), comprising a receiving wall (1) made of flexible, overlapping elastic lamellae (3) which are placed next to each other and secured on a frame (2), forming openable insert openings (10) between the overlapping regions in an initial position. In order to securely hold objects which differ in shape and size it is proposed that the lamellae (3) are cambered along their width and are provided with bent end sections (4) which are fixed to the frame (2).

### 1. FIELD OF THE INVENTION

The invention relates to an apparatus for holding objects, comprising a receiving wall made of flexible, overlapping elastic lamellae which are placed next to each other and secured on a frame, forming openable insert openings between the overlapping regions in an initial position.

### 2. DESCRIPTION OF THE PRIOR ART

In order to hold planar objects in particular visible fashion on a wall panel it is known (U.S. Pat. No. 4,559,728 A) to arrange flexible lamellae on a wall panel in a stacked manner above each other, so that the lamellae which are glued along their lower longitudinal edge to a base plate and which extend horizontally overlap with their free upper longitudinal edge regions with the fixed lower longitudinal edge region of the respective upward adjacent lamella, so that an insert pocket for the object to be held is obtained during the bending away of the upper longitudinal edge of a lamella between said lamella and the upwardly adjacent lamella. The disadvantageous aspect in these known wall panels is that the insertion depth and opening width of the insert pockets depend on the lamellae width extending with respect to height and are therefore limited. Moreover, the objects to be held in a visible fashion can only be inserted from above into the insert pockets, leading to difficulties in the holding of objects without sufficient flexural strength.

To ensure that flat objects such as paper or cardboard can be held both from below as well as from above on a wall panel, it is also known (U.S. Pat. No. 4,475,659 A) to tightly glue the horizontally arranged lamellae with their upper longitudinal edge, so that with their lower longitudinal edges which can be swiveled away from the wall panel they are in overlapping connection with the respective upper longitudinal edge of the downwardly adjacent lamellae. Since the free lower longitudinal edges of the lamellae carry an additional edge strip on the outside which between itself and the lower lamella edge forms an insert pocket which is accessible from above, planar objects can be inserted with their upper edge from below between two mutually overlapping lamellae and can then be inserted with their lower edge into an insert pocket accessible from above on the outside of the lower longitudinal edge of a respectively lower situated lamella, so that the object supported in a lower insert pocket can now also be fixed in the region of its upper edge between the lamellae. The limitations concerning the opening width and the insert depth of the insert pocket also applies to these known wall panels which are therefore substantially only suitable for receiving planar objects.

If it is intended to arrange three-dimensional objects instead of planar ones so as to be ready for removing, receiving walls with pockets are used in which such corporeal objects can be inserted. The disadvantageous aspect in these receiving walls provided with receiving pockets is that the pockets will predetermine a certain arrangement of the objects to be received. Moreover, the pocket size determines the size of the objects to be received, with objects which are smaller than the pockets no longer being visible. An additional factor is that the pockets are generally not suitable for receiving papers in a clear arrangement.

### SUMMARY OF THE INVENTION

The invention is thus based on the object of providing an apparatus for holding objects of the kind mentioned above in such a way that different objects, irrespective of their shape and size, can be arranged in a clear manner on the receiving wall.

The invention achieves the object in such a way that the lamellae are cambered along their width-and are provided with bent end sections which are fixed to the frame.

As a result of the structure of the receiving wall which is made up of individual, mutually overlapping lamellae, the continuous insert openings which are obtained between the superimposed longitudinal edge regions of the lamellae can be used in the known manner for a substantially free arrangement of the objects to be attached to the surface of the wall panel, but without the thus usually entailing limitation concerning the opening width and the insert depth because the lamellae which are merely fastened through the bent end sections to the frame can be bent up about a transversal axis to the longitudinal direction of the lamellae between said end sections by using the lamella length as a bending length. Since the insert openings between the mutually overlapping lamellae, starting out from a closed position with adjacent overlapping regions, can thus be opened within a comparatively large range to a differently wide extent, it is possible to fixedly clamp not only planar but also three-dimensional objects within insert openings between the mutually overlapping lamellae, which objects would otherwise only be insertable in receiving pockets. Notice must be taken in this connection that due to the cambering of the lamellae relative to their width in cooperation with the bent end sections which are fastened to a frame, tension states are achieved which permanently ensure the required clamping force. The bent end sections of the lamellae also ensure length compensation required for a larger deflection of the lamellae between their end sections, so that the different opening widths which are required for receiving objects of different thickness can easily be ensured in the region of the insert openings. The handling of the receiving wall is entirely simple because it is merely necessary to deflect the lower of the two lamellae forming an insert opening with the object to be inserted into the insert opening until the gradually opening insert opening shows the width required for receiving the respective object before the object is pushed between the overlapping lamellae and is tightly clamped in the receiving wall by the elastic return of the bent lamellae. It is irrelevant for the function of the wall panel in which direction the lamellae extend and on which side they overlap.

In order to provide especially advantageous constructional conditions concerning the restoring forces and the length compensation, the bent end sections can form legs which are bent back in a U-shaped way which are joined to the frame in a deflection-resistant way. As a result of the legs which are bent back in a U-shaped manner, an enlarged bending region is obtained in comparison with legs bent off in a rectangular fashion, which bending region entails an improved spring effect for the mutually overlapping lamellae.

In order to ensure a secure fixing of different objects between the mutually overlapping lamellae, it is necessary to ensure a sufficient overlapping width. If the overlapping region of the lamellae is within a quarter and half the width of the lamellae, it is possible to meet the occurring requirements in a relatively favorable manner. Especially advantageous holding conditions are obtained in this connection when the lamellae overlap by one-third of their width.

In order to utilize the restoring effect after the bending of the lamellae which is caused by the cambering and the preferably U-shaped bent-back end sections, the lamellae must be provided with a sufficiently flexible configuration. For this purpose the lamellae can be made of plastic. Favorable material properties can only be used in an economic manner when the lamellae consist of cambered strips of sheet metal.

### BRIEF DESCRIPTION OF THE DRAWINGS

The subject matter of the invention is shown by way of example in the enclosed drawings, wherein:

FIG. 1 shows an apparatus in accordance with the invention for holding objects in a sectional, simplified and partly elevated top view;

FIG. 2 shows a sectional view along the line II-II in FIG. 1 on an enlarged scale, and

FIG. 3 shows a sectional view along line Ill-Ill in FIG. 2.

### DESCRIPTION OF THE PREFERRED EMBODIMENTS

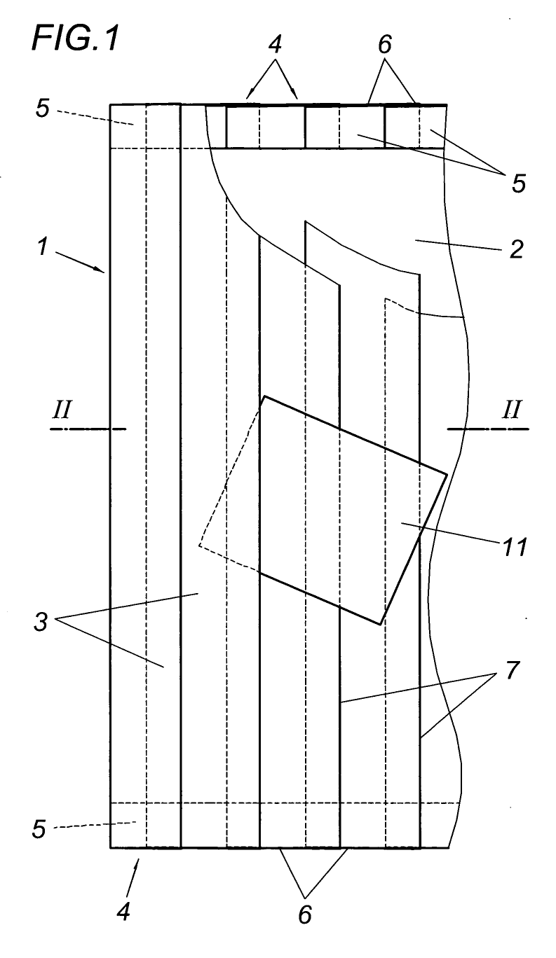

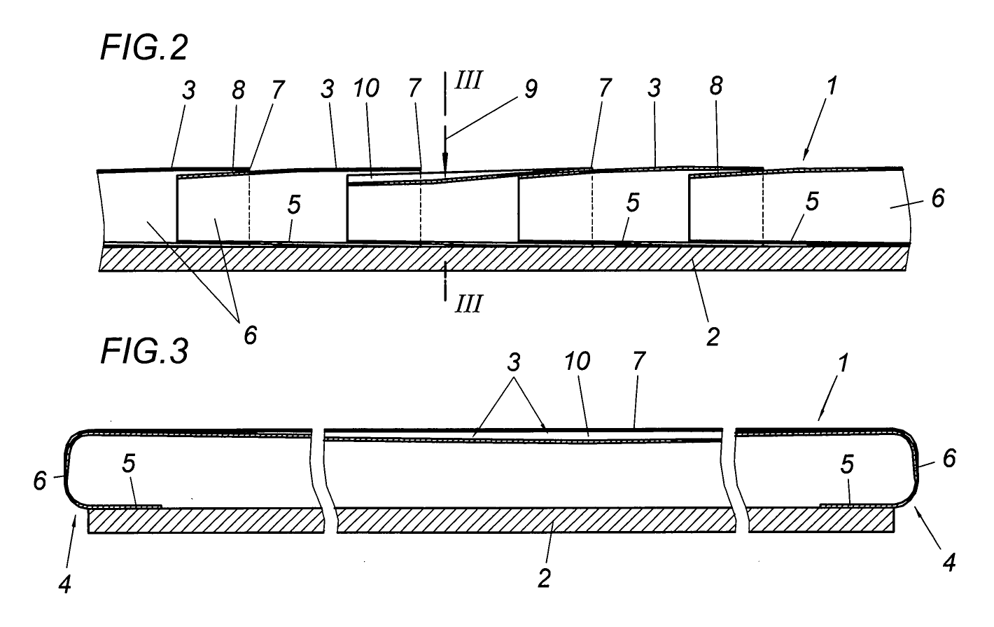

The receiving wall 1 according to the shown embodiment comprises a frame 2 which consists of a supporting plate or a supporting frame and on which flexible lamellae 3 are arranged which are cambered transversally to their width. They are arranged next to one another with a mutual overlapping on their longitudinal edge in the region of one-third of the lamellae width, as is shown in FIGS. 1 and 2. The relevant aspect for the construction of the receiving wall 1 is that the mutually overlapping lamellae 3 are provided with bent-off end sections 4 which are preferably bent back in a U-shaped manner and whose free legs 5 are fastened to the frame 2 by a glued connection for example. The web 6 of the U-like end sections 4 which projects up from the free legs 5 not only determines a predetermined distance of the lamellae 3 from the frame 2, but also produces a tensional state in the same due to the flections in the transitional region to the free legs 5 on the one hand and to the lamellae 3 in cooperation with the cambering of the lamellae 3 on the other hand, which tensional state ensures the mutual contact of the lamellae 3 in the overlapping region under a respective pretension. Objects can thus be clamped between the grasping longitudinal edge 7 and the grasped region 8 of the respectively adjacent lamella 3, which objects are inserted between the longitudinal edge 7 and the overlapped region 8 of two mutually adjacent lamellae 3. For this purpose it is merely necessary to push the lamella 3 which is grasped by the longitudinal edge 7 against the frame 2 away from the longitudinal edge 7 according to arrow 9 of FIG. 2, so that as a result of the deflection of the lamella 3 which is loaded in this way and the longitudinal edge 7 of the grasping lamella 3 an insert opening 10 will open through which the object to be fastened to the receiving wall 1 can be inserted between the respective pair of lamellae. Since the webs 6 of the end sections 4 ensure an adjusted length compensation, the insert openings 10 can be widened towards the frame 2, which also allows the holding of thicker objects between the mutually overlapping lamellae 3. With the relief of the deflected lamella 3, the elastic restoring forces will become effective which produce the secure clamping of the object to be held between the mutually overlapping lamellae 3. FIG. 1 shows this clamping holder for a planar object 11 such as a sheet of paper. FIGS. 2 and 3 show directly that with the increasingly larger insert openings 10 it is possible to arrange other objects such as dictating machines, key rings, writing accessories, mobile phones and the like in any desired arrangement on the receiving wall 1.

It is understood that the invention is not limited to the illustrated embodiment because it is only relevant that cambered lamellae are arranged in overlapping arrangement next to one another, whereby it is necessary to ensure through bent-off end sections on the one hand that a sufficient opening width of the insert openings arising between the overlapping lamellae is obtained and on the other that there are sufficient restoring and clamping forces.

1. An apparatus for holding objects, comprising a receiving wall made of flexible, overlapping elastic lamellae which are placed next to each other and secured on a frame, forming openable insert openings between the overlapping regions in an initial position, characterized in that the lamellae (3) are cambered along their width and are provided with bent end sections (4) which are fixed to the frame (2).

2. An apparatus as claimed in claim 1, characterized in that the bent end sections (4) form legs (5) which are bent back in a U-shaped way and are joined to the frame (2) in a deflection-resistant way.

3. An apparatus as claimed in claim 1, characterized in that the overlapping region of the lamellae (3) is between a quarter and a half of the width of the lamellae.

4. An apparatus as claimed in claim 3, characterized in that the lamellae (3) overlap by one-third of their width.

5. An apparatus as claimed in claim 1, characterized in that the lamellae (3) consist of cambered strips of sheet metal.
